(19) United States
(12) Patent Application Publication
(10) Pub. No.: US 2025/0165861 A1
(43) Pub. Date: May 22, 2025

(54) MODEL TRAINING SYSTEM, MODEL TRAINING METHOD AND APPARATUS

(71) Applicant: BEIJING VOLCANO ENGINE TECHNOLOGY CO., LTD., Haidian District, Beijing (CN)

(72) Inventors: Han QIAN, Beijing (CN); Dongyan ZHOU, Beijing (CN); Rui SHI, Beijing (CN)

(21) Appl. No.: 18/841,609

(22) PCT Filed: Jun. 5, 2023
(86) PCT No.: PCT/CN2023/098217

§ 371 Date: Aug. 26, 2024

(30) Foreign Application Priority Data
Jul. 5, 2022 (CN) 202210792462.6

(51) Int. Cl. G06N 20/00

(52) U.S. Cl. CPC G06N 20/00

(57) ABSTRACT

A model training system comprises: a source data processing module and one or more training frameworks, wherein the training framework comprises a training adaptation module and a training module, wherein the source data processing module performs data format conversion on an input data set corresponding to service requirements, so as to obtain initial training data in a preset general format, and outputs the initial training data to a target training framework corresponding to the service requirements; converting the initial training data by means of a target training adaptation module comprised in the target training framework, so as to obtain target training data conforming to a specified data format supported by a target training module, and outputting the target training data to the target training module for model training, so as to perform training to obtain a model satisfying a training end condition.

### CROSS-REFERENCE TO RELATED APPLICATIONS

This application claims the priority of a CN patent application filed on Jul. 5, 2022 with the application Ser. No. 202210792462.6 and entitled “Model Training System, Model Training Method and Apparatus”, which is hereby incorporated by reference in its entirety into the present application.

### TECHNICAL FIELD

The present disclosure relates to the technical field of data processing, in particular to a model training system, a model training method and an apparatus.

### BACKGROUND

In the model training scenario, training speed is one of the most important indexes evaluation for assessing the performance of the training framework. The training framework includes a large number of heterogeneous components, such as various types of trainers. In addition, there are also various types of storage and data formats for training data.

### SUMMARY

The present disclosure provides a model training system, a model training method and an apparatus.

In a first aspect, an embodiment of the present disclosure provides a model training system, comprising:
a source data processing module for converting an input data set corresponding to service requirements into a preset general format, taking a data set conforming to the preset general format as initial training data and sending the initial training data to a target training adaptation module in the model training system corresponding to the service requirements;
the target training adaptation module for converting the initial training data into a specified data format supported by a target training module corresponding to the service requirements to obtain target training data conforming to the specified data format, and outputting the target training data to the target training module;
the target training module for performing model training according to the service requirements and the received target training data, so as to train and obtain a model satisfying a training completion criterion.

In some embodiments, the preset general format includes a data header, metadata and a data part; wherein the data header is for indicating the attribute information of the data set, the metadata is for indicating the data types of the features of the initial training data, and the data part is for storing the features of the initial training data;

Wherein the attribute information includes one or more of a size of the data set, a data coding mode pre-specified by the target training module, a protocol version number or a magic number.

In some embodiments, the target training adaptation module is specifically for parsing the initial training data to obtain the attribute information of the data set, the features of the sample data and the data types of the features; and encapsulating the attribute information of the data set, the features of the sample data and the data types of the features based on a data encapsulation rule corresponding to the specified data format supported by the training module to obtain the target training data.

In some embodiments, the source data processing module is specifically for parsing the data set to obtain the attribute information of the data set, the features of the sample data and the data types of the features; and encapsulating the attribute information of the data set, the features of the sample data and the data types of the features according to a data encapsulation rule corresponding to the preset general format to obtain the initial training data, and sending the initial training data to the target training adaptation module.

In some embodiments, the source data processing module sends the initial training data in the preset general format to the target training adaptation module through any one of an anonymous pipeline, a named pipeline, a socket mode or a shared memory mode.

In some embodiments, the system further comprises a source data reading module for supporting the access of various types of data sources, reading a data set required by the service requirements from a specified data source corresponding to the service requirements, and outputting the read data set to the source data processing module for data format conversion.

In some embodiments, the source data reading module is specifically used for invoking a software development kit corresponding to the specified data source, accessing the specified data source by running the software development kit, and reading the data set required by the service requirements.

In a second aspect, the present disclosure provides a training method, comprising:
invoking a source data processing module to convert an input data set corresponding to service requirements into a preset general format, and taking a data set conforming to the preset general format as initial training data and sending the initial training data to a training adaptation module corresponding to the service requirements in a model training system;
invoking the training adaptation module to convert the initial training data into a specified data format supported by a target training module in the model training system corresponding to the service requirements to obtain target training data conforming to the specified data format, and outputting the target training data to the training module;
invoking the training module to perform model training according to the service requirements and the received target training data, so as to train and obtain a model satisfying a training completion criterion.

In some embodiments, the preset general format includes a data header, metadata and a data part; wherein the data header is for indicating the attribute information of the data set, the metadata is for indicating the data types of the features of the initial training data, and the data part is for storing the features of the initial training data;

Wherein, the attribute information includes one or more of a size of the data set, a data coding mode pre-specified by the training module, a protocol version number or a magic number.

In a third aspect, the present disclosure provides an electronic device comprising: a memory and a processor;
the memory being configured to store computer program instructions;
the processor being configured to execute the computer program instructions to cause the electronic device to implement the model training method according to the second aspect and any embodiment of the second aspect.

In a fourth aspect, the present disclosure provides a readable storage medium comprising: computer program instructions; the electronic device executing the computer program instructions to cause the electronic device to implement the model training method according to the second aspect and any embodiment of the second aspect.

In a fifth aspect, the present disclosure provides a computer program product, comprising: at least one processor of the electronic device executing the computer program product to cause the electronic device to implement the model training method according to the second aspect and any embodiment of the second aspect.

In a sixth aspect, the present disclosure provides a computer program comprising instructions which, when executed by a processor, implement the model training method according to the second aspect and any embodiment of the second aspect.

### BRIEF DESCRIPTION OF THE DRAWINGS

The drawings, which are incorporated in and constitute a part of this description, illustrate embodiments consistent with the present disclosure and, and together with the description, serve to explain the principles of the present disclosure.

In order to more clearly illustrate the technical solutions in the embodiments of the present disclosure or the related technology, a brief introduction will be given below for the drawings required to be used in the description of the embodiments or the related technology. Apparently, for an ordinary skilled in the art, he or she may also obtain other drawings according to such drawings without paying innovative efforts.

FIG. 1 is a schematic diagram of an overall architecture of a model training system provided by some embodiments of the present disclosure;

FIG. 2 is a schematic diagram of an overall architecture of a model training system provided by other embodiments of the present disclosure;

FIG. 3 is a schematic diagram of a data structure of a preset general format provided by some embodiments of the present disclosure;

FIG. 4 is a flow diagram of a model training method provided by some embodiments of the present disclosure;

FIG. 5 is a flow diagram of a model training method provided by some embodiments of the present disclosure;

FIG. 6 is a schematic structural diagram of an electronic device provided by some embodiments of the present disclosure.

### DETAILED DESCRIPTION

In order that the above objects, features and advantages of the present disclosure may be more clearly understood, the scheme of the present disclosure will be further described below. It is to be noted that, if without conflict, the embodiments and the features in the embodiments of the present disclosure can be combined with each other.

In the following description, numerous specific details are set forth in order to provide a thorough understanding of the present disclosure, but the present disclosure may be practiced otherwise than as described herein; obviously, the embodiments disclosed in the specification are only a portion of the embodiments of the present disclosure, and not all embodiments.

At present, the training frameworks has their own respective implementation methods for reading data in different data formats, and there are already a large number of heterogeneous components in each training framework that need to be adapted, such as tensorflow, pytorch, etc. In addition, there are also many types of data storage and data formats, for example, data storage types include object storage, streaming storage, etc., and data formats include csv, parquet, text, etc. However, the current training frameworks focus on the training algorithms, and pay little attention to the generality of the framework, which leads to the need for users to implement a set of codes on each training framework separately for each storage type and each data format, resulting in high complexity and time-consuming of data reading when the whole training framework performs training, which also seriously affects the training speed.

Based on this, the present disclosure provides a model training system, a model training method and an apparatus, wherein the system comprises a source data processing module and one or more training frameworks, and the training framework comprises a training adaptation module and a training module; wherein the source data processing module is used for performing data format conversion on an input data set corresponding to service requirements to obtain initial training data in a preset general format, and outputting the initial training data to a target training framework corresponding to the service requirements; a target training adaptation module comprised in the target training framework converts the initial training data in a preset general format to obtain target training data in a specified data format supported by the target training module, and outputs the target training data to the target training module for model training, so as to train and obtain a model satisfying a training completion criterion.

By decoupling data reading from the training framework, the system makes the training framework pay more attention to the training itself without paying attention to the data format of the required training data at the front end. The source data processing module in the model training system completes the conversion from various data formats to the preset general format, and the training adaptation module in the training framework completes the conversion from the preset general format to the specified data format matched with the training module in the training framework, which improves the training speed and greatly reduces the complexity of realizing data reading codes in the training framework.

The change of complexity is illustrated with examples. Suppose there are M data formats and N training frameworks, the complexity of data reading in the existing model training system is M*N at present, while the complexity of data reading in the model training system provided by the present disclosure is M+N. By comparison, the complexity of the model training system provided by the present disclosure is low, and the improvement of the training speed is also extremely significant.

Next, the model training system and model training method provided by the present disclosure will be introduced with examples through several specific embodiments combined with actual scenes and drawings.

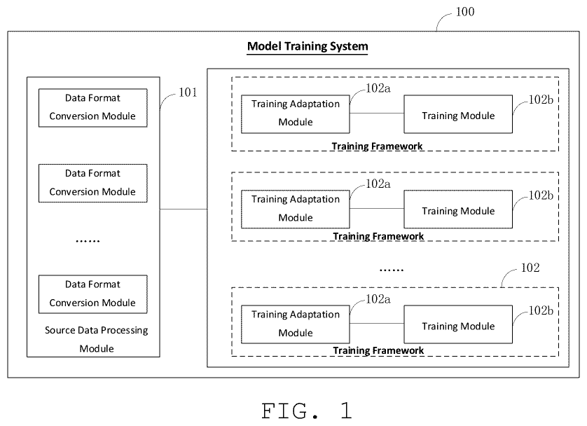

FIG. 1 is a schematic diagram of an overall architecture of a model training system provided by the present disclosure. Referring to FIG. 1, a model training system 100 provided by this embodiment includes a source data processing module 101 and various training frameworks 102, wherein each training framework 102 includes a training adaptation module 102a and a training module 102b.

A scheduling module (which can also be understood as a task scheduling module, not shown in FIG. 1) can be deployed in the model training system 100 to schedule tasks based on the received service requirements. For example, the scheduling module can issue corresponding tasks to the module that performs data reading, the source data processing module 101 and the target training framework 102 that matches the service requirements among a plurality of training frameworks comprised in the model training system, respectively, based on the service requirements. Each module that receives the task executes the corresponding operations.

When the data set corresponding to the service requirements is read out from the specified data source corresponding to the service requirements and input to the source data processing module 101, the source data processing module 101 is mainly responsible for converting the input data set of different data formats into a preset general format and sending it to the downstream training framework 102. Different data formats can include but are not limited to csv, parquet, text, json, tfrecord, etc. Among them, CSV (Comma-Separated Values) is a comma-separated value file format, parquet is a column storage format, text is a text format, json (JavaScript Object Notation, JS object notation) is a lightweight data exchange format, and tfrecord is a binary data format used by tensorflow.

In some embodiments, the source data processing module 101 can send data in a preset general format to the training framework 102 through an anonymous pipeline, a named pipeline, a socket mode or a shared memory mode.

An anonymous pipeline can be used for communication between processes, and is limited to communication between the local parent and child processes. This can be realized by means of files, that is, the model training system can create a file, which can be accessed by both the process invoked by the source data processing module for data format conversion and the process invoked by the training framework for data format conversion, wherein the process invoked by the source data processing module for data format conversion can write input into the file, and the process invoked by the training framework for data format conversion can read data from the file and no additional permissions such as ports and files are required to be provided. The anonymous pipeline is simple in structure and small in occupation.

A named pipeline is also a simple inter-process communication mechanism. When the model training system creates a named pipeline, it assigns a name to the pipeline. Any process (including the process invoked by the source data processing module for data format conversion and the process invoked by the training framework for data format conversion) can open the other end of the pipeline by this name, which can realize that the process be invoked in different ways and be more flexible.

Socket is an abstraction of ports for two-way communication between different application processes. A socket is one end of process communication on the network, which provides a mechanism for application process to exchange data using a network protocol. The source data processing module can write the initial training data in the preset general format into its corresponding socket, and the socket transmits these data to a socket corresponding to the target training framework through a transmission medium, so that the target training framework can receive this information.

Shared memory is a large-capacity memory that can be accessed by different central processors in a multiprocessor computing system. Shared memory is a communication method between multiple processes. This method is usually used for the communication between multiple processes of a program. In fact, multiple programs can also transfer information through shared memory. When the service requirements reach the model training system, it can trigger the creation of a shared memory area. The process invoked by the source data processing module for data format conversion writes the initial training data in the preset general format into the shared memory area, and the process invoked by the training framework for data format conversion reads the required initial training data in the preset general format from the shared memory area. The shared memory mode is the most efficient communication mechanism at present.

In some embodiments, data can be transmitted mainly through anonymous pipelines, which is simple to implement and does not require additional permissions such as ports and files. However, if the upper limit of pipeline cache is encountered, the data reading and writing speed will be slow, now the mode is switched to a socket mode, which needs to support port-related scheduling to prevent conflicts, and too many services cannot run on the device, otherwise the binding will fail. Shared memory mode also requires some local permissions and is complex to develop, so some designated tasks can be set to use the shared memory mode.

Alternatively, in some embodiments, a corresponding data transmission mode can be pre-configured based on different types of service requirements, and when the model training system receives the service requirements, the initial training data can be transmitted to the training framework by using the pre-configured mode. And during the configuration, the requirements on throughput by different types of service requirements can be considered.

It should be noted that users can choose an appropriate way to transmit the initial training data according to other strategies.

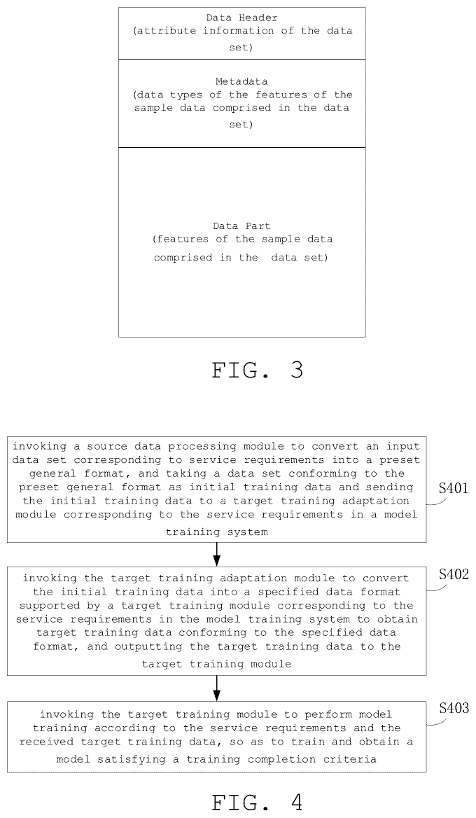

In some embodiments, the source data processing module 101 may include a plurality of data format conversion modules, each of which is used for supporting the conversion of a preset data format into a preset general format, and the preset data formats respectively corresponding to the plurality of data format conversion modules are different. In the present disclosure, the specific data structure of the preset general format is not limited, and reference can be made to the following detailed description of the embodiment shown in FIG. 3.

For example, the source data processing module 101 supports the conversion of five data formats, namely csv, parquet, text, json and tfrecord, to the preset general format, then the source data processing module 101 may include five data format conversion modules, which are data format conversion modules 1 to 5, respectively, wherein the data format conversion module 1 is used to convert the csv format into the preset general format, the data format conversion module 2 is used to convert the parquet format into the preset general format, the data format conversion module 3 is used to convert the text format into the preset general format, the data format conversion module 4 is used to convert the json format into the preset general format, and the data format conversion module 5 is used to convert tfrecord format into the preset general format.

In the process of data format conversion, the data format conversion module obtains the attribute information of the data set, the features of each sample data comprised in the data set and the data types of the features by parsing the data set in the corresponding data format, and then encapsulates the attribute information of the data set, the features of each sample data comprised in the data set and the data types of the features based on the data encapsulation rule for the preset general format to obtain the initial training data in the preset general format.

Wherein the attribute information of the data set may include, but is not limited to, a size of the data set, a data coding mode specified by the corresponding target training module, a magic number, a protocol version number and so on. The protocol version number mentioned here is the protocol version number of the data transmission protocol used for data transmission between the source data processing module and the training framework.

Illustratively, several data formats, namely csv, queue, text, json, and tfrecrd, are taken as examples to illustrate the manner that the source data processing module implements data format conversion.

1. Convert the csv format to the preset general format

Pieces of data can be read out firstly according to the line breaks, then the data is segmented based on separators to obtain multiple columns of data, and then the segmented multiple columns of data can be filled into the preset general format, thus completing the data format conversion.

2. Convert the parquet format to the preset general format

After an interface conversion logic is realized through the API provided by parquet, a batch of data can be read by directly invoking the API, and the read data conforms to the preset general format.

3. Convert the text format to the preset general format

The text format is similar to the csv format. First, pieces of data can be read according to the line breaks, then the data can be segmented based on separators to obtain multiple columns of data, and then the segmented multiple columns of data can be filled into the preset general format, thus completing the data format conversion.

4. Convert json format to the preset general format

Users need to firstly define a data description document (schema), then read json data piece by piece, and use jsonparser to parse the data according to the user-defined schema, and then fill it into the preset general format, thus completing the data format conversion.

5. Convert the tfrecord format to the preset general format

The data can be parsed by invoking the API provided by tfrecord, then the data of each row and column is read, and then the read data is filled into the preset general format, thus completing the data format conversion.

In some embodiments, it may be necessary to read data from a plurality of specified data sources based on the service requirements. In order to improve the processing efficiency of the source data processing module 101, data sets requiring data format conversion can be written into the source data processing module 101 concurrently through multiple threads. Wherein when writing, it can be realized by thread locking to avoid the phenomenon of chaotic data writing caused by multi-thread writing. Of course, it can also be realized by using a lock-free queue, where each thread writes the data set read from the specified data source into the data queue, and the source data processing module 101 reads the data set from the data queue and invokes a data format conversion module matching the data format adopted by the data set to perform data format conversion processing. It can be understood that the model training system can also solve the problem of chaotic data writing in other ways, which is not limited in the present disclosure.

With the model training system provided by the present disclosure, when a data set in a new data format needs to be used as training data for model training, a data format conversion module corresponding to the newly-added data format can be deployed in the source data processing module 101 to complete the conversion of the newly-added data format into the preset general format, and the training adaptation module 102a and the training module 102b in any training framework 102 at the back end need not be modified.

The training adaptation module 102 is mainly responsible for converting the initial training data from the preset general format to the specified data format supported by the training module 102b, and inputting the data to the connected training module 102b for model training.

In some embodiments, the training adaptation module 102a specifically reads the initial training data in the preset general format from an anonymous pipeline, a named pipeline, a socket or a shared memory based on the interaction mode (which can also be understood as a communication mechanism) defined by the source data processing module 101, and then parse the initial training data in the preset general format to obtain the attribute information of the data set, the features of the sample data and the data types of the features; based on the data encapsulation rules corresponding to the specified data format supported by the training module 102b connected with the training adaptation module 102a, the attribute information of the data set, the features of the sample data and the data types of the features are encapsulated to obtain the target training data in the specified data format supported by the training module 102a, and then the target training data can be input into the training module 102b for model training.

For example, the model training system includes two training frameworks: tensorflow and pytorch, then tensorflow includes a training adaptation module 1 corresponding to tensorflow, and pytorch includes a training adaptation module 2 corresponding to pytorch.

Any type of training framework can be deployed in the model training system 100, and a training adaptation module capable of converting the preset general format to a specified data format supported by the corresponding training module in the training framework is deployed in the training framework.

Based on the above introduction, it can be seen that when a new training framework 102 needs to be deployed in the model training system, a training adaptation module capable of converting the preset general format into a specified data format supported by the corresponding training module in the training framework can be developed and deployed in the training framework, so that the adaptation between data in the preset general format and the training module comprised in the newly added training framework can be realized, and the user's demand for flexible expansion of a training framework can be met, and there is no need to modify the source data processing module 101 at the front end.

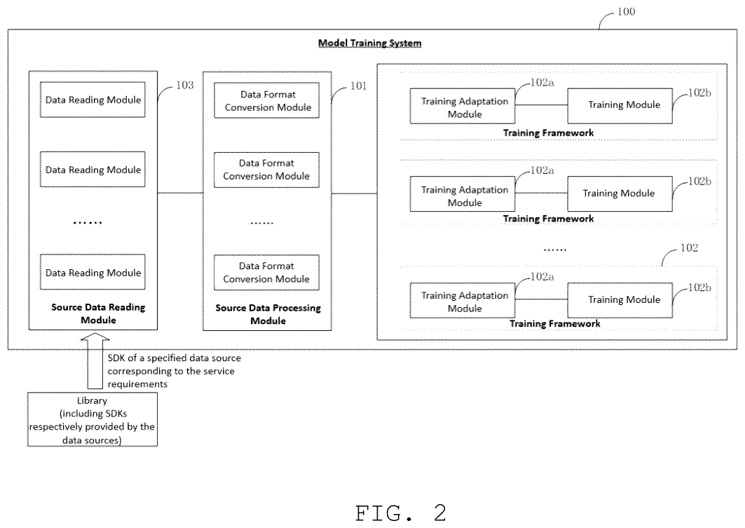

FIG. 2 is a schematic diagram of an overall architecture of a model training system provided by other embodiments of the present disclosure. Referring to FIG. 2, the model training system provided by this embodiment further includes a source data reading module 103 on the basis of the embodiment shown in FIG. 1.

The source data reading module 103 is arranged at the front end of the source data processing module 101, and is used for supporting the access of various types of data sources, reading a data set required by the service requirements from the data source and inputting it to the source data processing module for data format conversion. Combined with the introduction of the embodiment shown in FIG. 1, the scheduling module in the model training system can issue a data reading task to the source data reading module 103 based on the service requirements, and the source data reading module 103 reads the required data set from the specified data source corresponding to the service requirements after receiving the data reading task.

As a possible implementation, a library can be configured in the model training system to store Software Development Kits (SDK) respectively provided by different types of data sources, and the source data reading module 103 can invoke a SDK stored in the library for a specified data source corresponding to the service requirements based on the service requirements, and the source data reading module 103 can access the specified data source and read the data in the specified data source by running the SDK.

For example, the model training system supports reading data from three data sources, namely HDFS, S3 and Kafka, then SDKs respectively provided by three types of data sources, namely, HDFS, S3 and Kafka, can be stored in the library, so that the source data reading module 103 can successfully read the data in the respective data source by invoking the SDK corresponding to the data source.

In order to improve the data reading efficiency, the source data reading module 103 may include a plurality of data reading modules, which can perform data reading in parallel, and the plurality of data reading modules can respectively support invoking SDKs of different types of data sources, and connect the data reading modules with corresponding types of data format conversion modules in the source data processing module 101 at the back end.

It should be noted that data can be stored in one or more data formats in the data source, so the data reading module can be connected with a plurality of data format conversion modules at the back end.

In some embodiments, if the model training system needs to support reading data from a newly-added type of data source, the SDK corresponding to the newly-added type of data source can be deployed in the library of the model training system, so that the source data reading module 103 can successfully read data without any modification to the source data processing module 101 and the training framework 102 at the back end, which is convenient for users to flexibly expand and access the data sources.

Combined with the embodiments shown in FIG. 1 and FIG. 2, the model training system provided by the present disclosure can realize multi-thread data reading, which can not only improve the training speed, but also break the limitation of single-thread training in the existing training frameworks.

Next, the data structure of the preset general format is introduced by way of example. FIG. 3 is a schematic diagram of a data structure of a preset general format provided by some embodiments of the present disclosure. As shown in FIG. 3, the preset general format includes a data header, metadata and a data part.

The header describes the attribute information of the data set, in which the attribute information can include one or more of a size of the data set, a data coding mode specified by the target training module corresponding to the service requirements, a protocol version number or a magic number. The magic number can solve the problem that the whole data cannot be parsed because of the erroneous placement of data bits. It can be understood that, with the continuous optimization of the model training mode, the attribute information of the data set stored in the header can be adjusted, for example, new attribute information can be added or some attribute information can be reduced.

Metadata is mainly used to describe the data types of the features of the sample data comprised in the data set. The data types of the features mentioned here may include, but are not limited to, integer, floating point, short integer, etc.

The data part is used to store the features of the sample data, wherein each sample data is composed of a plurality of features described by the foregoing metadata.

It should be noted that the data structure of the preset general format is not limited to the example in the embodiment shown in FIG. 3, and can also be implemented as other data structures. The present disclosure does not limit the specific data structure adopted by the preset general format.

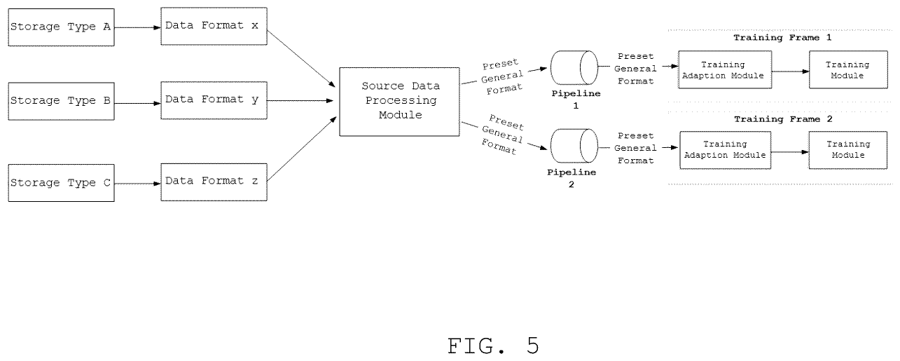

FIG. 4 is a flow diagram of a model training method provided by some embodiments of the present disclosure. The method can be implemented by the model training system of the embodiments shown in FIG. 1 or FIG. 2. Please refer to FIG. 4, the method provided by this embodiment includes:

S401: invoking a source data processing module to convert an input data set corresponding to service requirements into a preset general format, and taking a data set conforming to the preset general format as initial training data and sending the initial training data to a target training adaptation module corresponding to the service requirements in a model training system.

Service requirements are used to refer to model training requirements corresponding to the service, and the service requirements can be generated based on, but not limited to, operation instructions input by users. Wherein the service can be any service, and the type of service is not limited in the present disclosure, for example, it can be image recognition service, speech recognition service, text processing service and so on. The data sets required by different services are different, for example, the data set required for the image recognition service includes sample image data, the data set required for the speech recognition service includes audio sample data, and the data set required for the text processing service is text sample data.

The data set can be obtained by the source data reading module in the model training system invoking an SDK corresponding to the specified data source corresponding to the service requirements and then reading from the specified data source. Wherein the specified data source corresponding to the service requirements can be one or more.

If the number of specified data source is multiple, a plurality of data reading submodules in the source data reading module can be invoked to concurrently read data sets required by the service requirements from a plurality of specified data sources, so as to improve data reading efficiency.

Combined with the aforementioned introduction of the model training system, this embodiment can invoke the source data processing module to parse the sample data comprised in the data set to obtain the attribute information of the data set, the features of the sample data and the data types of the features, and then write the attribute information of the data set into the data header, the features of the sample data into the data part, and the data types of the features into the metadata part according to the data encapsulation rule for the preset general format, and re-encapsulate to obtain the initial training data.

In addition, the source data processing module can send the initial training data to the target training adaptation module in the target training framework corresponding to the service requirements through any one of an anonymous pipeline, a named pipeline, a socket or a shared memory. The specific way to send the initial training data to the target training adaptation module can be determined by the user based on, but not limited to, the occupation of the hardware resources carried by the model training system, the data processing capability of the hardware resources, etc., and can also be determined by the model training system itself.

S402: invoking the target training adaptation module to convert the initial training data into a specified data format supported by a target training module in the model training system corresponding to the service requirements to obtain target training data to the specified data format, and outputting the target training data to the target training module.

The target training adaptation module is invoked to read the initial training data in a general data format from the corresponding anonymous pipeline, named pipeline, socket or shared memory based on the interaction mode defined by the upstream source data processing module. Then, the initial training data in the general data format is parsed to obtain the attribute information of the data set, the features of the sample data and the data types of the features. Then, the attribute information of the data set, the features of the sample data and the data types of the features are re-encapsulated according to the data encapsulation rule corresponding to the specified data format supported by the target training module to obtain the target training data that can be directly input to the target training module.

S403: invoking the target training module to perform model training according to the service requirements and the received target training data, so as to train and obtain a model satisfying a training completion criterion.

The target training module can load the model to be trained, and input the target training data into the model to be trained for training based on the service requirements. Through continuous iterative training, a trained model can be obtained until the training completion criterion is satisfied.

The method provided by this embodiment carries out model training by adopting a model training system in which data reading is decoupled from the training framework, so as to realize training acceleration. Wherein, the source data processing module supports the access of a plurality of different types of data sources, and the initial training data in the preset general format is obtained by invoking the source data processing module to perform data format conversion on the required data set read from the specified data source based on the service requirements, and is output to the target training framework corresponding to the service requirements; the target training adaptation module comprised in the target training framework converts the initial training data in the preset general format to obtain target training data conforming to a specified data format supported by the target training module, and outputs the target training data to the target training module for model training, so as to train and obtain a model satisfying the training completion criterion.

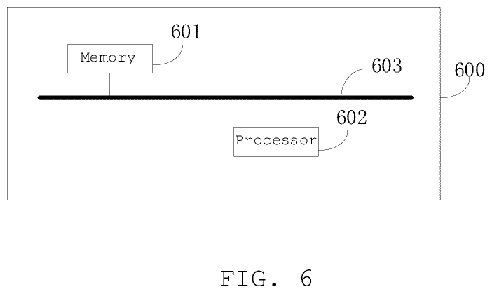

Please refer to FIG. 5. In a specific embodiment, it is assumed that there are three data sources at the front end that use storage type A, storage type B and storage type C respectively to store data, and two training frameworks at the back end have corresponding model training service requirements. The source data reading module of the model training system can read the data required by the service requirements by invoking the SDKs corresponding to three data sources respectively, wherein the data of storage type A is read as data format X, the data of storage type B is read as data format Y, and the data of storage type C is read as data format Z. Then the source data processing module in the model training system converts data sets in data format X, data format Y and data format Z into the preset general format to obtain the initial training data, and stores the initial training data required by the training framework 1 into the designated pipeline/socket/designated shared memory corresponding to the training framework 1. The training adaptation module in the training framework 1 reads the required initial training data from the corresponding pipeline/socket/designated shared memory, re-parses and encapsulates it, and then inputs it into the training module comprised in the training framework 1 at the back end for model training.

Similarly, the source data processing module stores the initial training data required by the training framework 2 into the designated pipeline/socket/designated shared memory corresponding to the training framework 2, and the training adaptation module in the training framework 2 reads the required initial training data from the corresponding pipeline/socket/designated shared memory, re-parses and encapsulates it, and then inputs it into the training module comprised in the training framework 2 at the back end for model training.

If the existing model training system is adopted, six kinds of codes need to be deployed in the whole model training system for data reading, while the solution provided by the present disclosure can realize data reading through five kinds of codes. With the increasing variety of data sources and data formats, and with the increasing number of training frameworks, the model training system provided by the present disclosure has a more obvious effect in training speed improvement as compared with the existing model training system. And the source data processing module and the training framework are deployed in a layered way, which is beneficial to the maintenance and flexible expansion of the whole model training system and can meet the increasing model training requirements of users.

Illustratively, the present disclosure also provides an electronic device. FIG. 6 is a schematic structural diagram of an electronic device provided by some embodiments of the present disclosure. As shown in FIG. 6, an electronic device 600 provided by this embodiment includes a memory 601 and a processor 602.

The memory 601 can be a separate physical unit and can be connected with the processor 602 through a bus 603. The memory 601 and the processor 602 can also be integrated and implemented by hardware, etc.

The memory 601 is used for storing program instructions, and the processor 602 invokes the program instructions to execute the model training method provided by any of the above method embodiments.

Alternatively, when part or all of the methods in the above embodiments are implemented by software, the above electronic device 600 may only include the processor 602. The memory 601 for storing programs is located outside the electronic device 600, and the processor 602 is connected with the memory through a circuit/wire for reading and executing the programs stored in the memory.

The processor 602 may be a central processing unit (CPU), a network processor (NP) or a combination of CPU and NP.

The processor 602 may further include a hardware chip. The hardware chip can be an application-specific integrated circuit (ASIC), a programmable logic device (PLD) or a combination thereof. The PLD may be a complex programmable logic device (CPLD), a field-programmable gate array (FPGA), a generic array logic (GAL) or any combination thereof.

The memory 601 may include a volatile memory, such as a random-access memory (RAM). The memory can also include non-volatile memory, such as flash memory, hard disk drive (HDD) or solid-state drive (SSD). The memory may also include a combination of the above kinds of memories.

The present disclosure also provides a readable storage medium, comprising computer program instructions, which, when executed by at least one processor of the electronic device, cause the electronic device to implement the model training method provided in any of the above method embodiments.

The present disclosure also provides a computer program product, which, when run on a computer, causes the computer to implement the model training method provided in any of the above method embodiments.

It is to be noted that terms used herein to describe relations such as “first” and “second” are only used to distinguish one entity or operation from another, but shall not require or suggest that these entities or operations have such an actual relation or sequence. Moreover, the term “comprising”, “including” or any other variants intend to cover other nonexclusive containing relationships to ensure that a process, method, article or device comprising a series of elements comprises not only those elements but also other elements not explicitly listed, or further comprises elements innate to the process, method, article or device. Without more limitations, an element defined by the phrase “comprising one . . . ” does not exclude the case that the process, method, article or device comprising said element still comprises other identical elements.

The previous description is only for the purpose of describing particular embodiments of the present disclosure, so as to enable those skilled in the art to understand or implement the present disclosure. A plurality of modifications to these embodiments are obvious for those skilled in the art. The general principle defined herein can be realized in other embodiments without deviating from the spirit or scope of the present disclosure. Therefore, the present disclosure will not be limited to these embodiments as shown herein, but is to conform to the broadest scope that is consistent with the principle and novel features as disclosed herein.

What is claimed is:

1-13. (canceled)

14. A model training method, comprising:
invoking a source data processing module to convert an input data set corresponding to service requirements into initial training data conforming to a preset general format, and send the initial training data to a target training adaptation module corresponding to the service requirements in a model training system;
invoking the target training adaptation module to convert the initial training data into target training data conforming to a specified data format supported by a target training module corresponding to the service requirements in the model training system, and to output the target training data to the target training module; and
invoking the target training module to perform model training according to the service requirements and the target training data, so as to train and obtain a model satisfying a training completion criterion.

15. The method according to claim 14, wherein the preset general format comprises a data header, metadata and a data part; wherein the data header is for indicating attribute information of the input data set, the metadata is for indicating data types of features of the initial training data, and the data part is for storing the features of the initial training data;
wherein the attribute information includes one or more of a size of the input data set, a data coding mode pre-specified by the target training module, a protocol version number or a magic number.

16. The method according to claim 15, wherein the invoking the target training adaptation module to convert the initial training data into the target training data conforming to the specified data format and to output the target training data to the target training module comprises:
invoking the target training adaptation module to parse the initial training data and obtain the attribute information of the input data set, the features of the sample data and the data types of the features; and encapsulate the attribute information of the input data set, the features of the sample data and the data types of the features based on a data encapsulation rule corresponding to the specified data format supported by the target training module to obtain the target training data, and to send the target training data to the target training module.

17. The method according to claim 15, wherein the invoking the source data processing module to convert the input data set into the initial training data, and send the initial training data to a target training adaptation module, comprises:
invoking the source data processing module to parse the data set and obtain the attribute information of the input data set, the features of the sample data and the data types of the features; and encapsulate the attribute information of the input data set, the features of the sample data and the data types of the features according to a data encapsulation rule corresponding to the preset general format to obtain the initial training data, and to send the initial training data to the target training adaptation module.

18. The method according to claim 14, wherein the source data processing module sends the initial training data in the preset general format to the target training adaptation module through any one of an anonymous pipeline, a named pipeline, a socket mode or a shared memory mode.

19. The method according to claim 14, further comprising:
invoking a source data reading module supporting access of various types of data sources to read a data set required by the service requirements from a specified data source corresponding to the service requirements, and to output the read data set to the source data processing module for data format conversion.

20. The method according to claim 19, wherein the invoking the source data reading module to read the data set required by the service requirements from the specified data source comprises:
invoking a software development kit corresponding to the specified data source, accessing the specified data source by running the software development kit, and reading the data set required by the business requirements.

21. An electronic device comprising: a memory and a processor;
the memory being configured to store computer program instructions;
the processor being configured to execute the computer program instructions to cause the electronic device to implement the model training method comprising:
invoking a source data processing module to convert an input data set corresponding to service requirements into initial training data conforming to a preset general format, and send the initial training data to a target training adaptation module corresponding to the service requirements in a model training system;
invoking the target training adaptation module to convert the initial training data into target training data conforming to a specified data format supported by a target training module corresponding to the service requirements in the model training system, and to output the target training data to the target training module; and
invoking the target training module to perform model training according to the service requirements and the target training data, so as to train and obtain a model satisfying a training completion criterion.

22. The electronic device according to claim 21, wherein the preset general format comprises a data header, metadata and a data part; wherein the data header is for indicating attribute information of the input data set, the metadata is for indicating data types of features of the initial training data, and the data part is for storing the features of the initial training data;
wherein the attribute information includes one or more of a size of the input data set, a data coding mode pre-specified by the target training module, a protocol version number or a magic number.

23. The electronic device according to claim 22, wherein the invoking the target training adaptation module to convert the initial training data into the target training data conforming to the specified data format and to output the target training data to the target training module comprises:
invoking the target training adaptation module to parse the initial training data and obtain the attribute information of the input data set, the features of the sample data and the data types of the features; and encapsulate the attribute information of the input data set, the features of the sample data and the data types of the features based on a data encapsulation rule corresponding to the specified data format supported by the target training module to obtain the target training data, and to send the target training data to the target training module.

24. The electronic device according to claim 22, wherein the invoking the source data processing module to convert the input data set into the initial training data, and send the initial training data to a target training adaptation module, comprises:
invoking the source data processing module to parse the data set and obtain the attribute information of the input data set, the features of the sample data and the data types of the features; and encapsulate the attribute information of the input data set, the features of the sample data and the data types of the features according to a data encapsulation rule corresponding to the preset general format to obtain the initial training data, and to send the initial training data to the target training adaptation module.

25. The electronic device according to claim 21, wherein the source data processing module sends the initial training data in the preset general format to the target training adaptation module through any one of an anonymous pipeline, a named pipeline, a socket mode or a shared memory mode.

26. The electronic device according to claim 21, wherein the processor is configured to execute the computer program instructions to cause the electronic device to implement the model training method further comprising:
invoking a source data reading module supporting access of various types of data sources to read a data set required by the service requirements from a specified data source corresponding to the service requirements, and to output the read data set to the source data processing module for data format conversion.

27. The electronic device according to claim 26, wherein the invoking the source data reading module to read the data set required by the service requirements from the specified data source comprises:
invoking a software development kit corresponding to the specified data source, accessing the specified data source by running the software development kit, and reading the data set required by the business requirements.

28. A non-transitory readable storage medium comprising: computer program instructions;
the computer program instructions being executable by an electronic device to cause the electronic device to implement the model training method comprising:
invoking a source data processing module to convert an input data set corresponding to service requirements into initial training data conforming to a preset general format, and send the initial training data to a target training adaptation module corresponding to the service requirements in a model training system;
invoking the target training adaptation module to convert the initial training data into target training data conforming to a specified data format supported by a target training module corresponding to the service requirements in the model training system, and to output the target training data to the target training module; and
invoking the target training module to perform model training according to the service requirements and the target training data, so as to train and obtain a model satisfying a training completion criterion.

29. The non-transitory readable storage medium according to claim 28, wherein the preset general format comprises a data header, metadata and a data part; wherein the data header is for indicating attribute information of the input data set, the metadata is for indicating data types of features of the initial training data, and the data part is for storing the features of the initial training data;
wherein the attribute information includes one or more of a size of the input data set, a data coding mode pre-specified by the target training module, a protocol version number or a magic number.

30. The non-transitory readable storage medium according to claim 29, wherein the invoking the target training adaptation module to convert the initial training data into the target training data conforming to the specified data format and to output the target training data to the target training module comprises:
invoking the target training adaptation module to parse the initial training data and obtain the attribute information of the input data set, the features of the sample data and the data types of the features; and encapsulate the attribute information of the input data set, the features of the sample data and the data types of the features based on a data encapsulation rule corresponding to the specified data format supported by the target training module to obtain the target training data, and to send the target training data to the target training module.

31. The non-transitory readable storage medium according to claim 29, wherein the invoking the source data processing module to convert the input data set into the initial training data, and send the initial training data to a target training adaptation module, comprises:
invoking the source data processing module to parse the data set and obtain the attribute information of the input data set, the features of the sample data and the data types of the features; and encapsulate the attribute information of the input data set, the features of the sample data and the data types of the features according to a data encapsulation rule corresponding to the preset general format to obtain the initial training data, and to send the initial training data to the target training adaptation module.

32. The non-transitory readable storage medium according to claim 28, wherein the source data processing module sends the initial training data in the preset general format to the target training adaptation module through any one of an anonymous pipeline, a named pipeline, a socket mode or a shared memory mode.

33. The non-transitory readable storage medium according to claim 28, wherein the computer program instructions are executable by the electronic device to cause the electronic device to implement the model training method further comprising:
invoking a source data reading module supporting access of various types of data sources to read a data set required by the service requirements from a specified data source corresponding to the service requirements, and to output the read data set to the source data processing module for data format conversion.
